(19) United States
(12) Patent Application Publication
(10) Pub. No.: US 2014/0186645 A1
(43) Pub. Date: Jul. 3, 2014

(54) MANUFACTURE OF BEND INSENSITIVE MULTIMODE OPTICAL FIBER

(71) Applicant: OFS FITEL, LLC, Norcross, GA (US)

(72) Inventors: Daniel J. Briere, Fiskdale, MA (US); David Robert Knight, Spencer, MA (US)

(73) Assignee: OFS FITEL, LLC, Norcross, GA (US)

(21) Appl. No.: 13/732,818

(22) Filed: Jan. 2, 2013

(51) Int. Cl. C03B 37/012

(52) U.S. Cl. CPC C03B 37/01211
USPC 428/542.8; 65/412

(57) ABSTRACT

A method of assembling a preform for a bend-insensitive multimode optical fiber (BIMMF), includes providing a multimode core rod, a glass overclad tube, and a trench tube of down-doped quartz glass with a depressed refractive index sufficient to obtain a desired trench depth in a refractive index (RI) profile of a drawn fiber. The core rod is placed inside the trench tube, and the trench tube and the core rod are placed inside the overclad tube to define the preform. A top end of the trench tube is formed to contact an adjacent part of either the core rod or the overclad tube so that the trench tube is suspended to hang from the adjacent part when the preform is vertically oriented, and a bottom end of the trench tube is restrained from sinking into a lower portion of the preform when the preform is heated to collapse.

### BACKGROUND OF THE INVENTION

1. Field of the Invention

The present invention concerns the manufacture of optical fibers, particularly bend insensitive multimode fibers.

2. Discussion of the Known Art

Patent Application Pub. No. US 2009/0060437 (Mar. 5, 2009) discloses a bend insensitive, single mode fiber having a relatively low bend loss at a bend radius of about 4 to 15 mm. The disclosed fiber has a core and a cladding region for propagating light in a fundamental transverse mode. The cladding region includes (i) an outer cladding having a refractive index less than that of the core region, (ii) an annular pedestal region having a refractive index higher than that of the outer cladding and comparable to that of the core, (iii) an annular inner trench region disposed between the core and the pedestal region, the inner trench region having a refractive index less than that of the outer cladding, and (iv) an annular outer trench region disposed between the pedestal region and the outer cladding, the outer trench region having a refractive index less than that of the outer cladding. All relevant portions of the '437 Publication are incorporated by reference.

Typical bend insensitive multimode fibers (BIMMF) have a refractive index profile in which the fiber cladding contains a trench region or layer of depressed index glass. Such index profiles are disclosed in, e.g., U.S. Pat. No. 8,073,301 (Dec. 6, 2011)(see FIG. 2 and related text), and U.S. patent application Ser. No. 13/252,964 which was published as US 2012/0183267 on Jul. 19, 2012, all of which are incorporated by reference.

FIG. 1 is an example of a refractive index difference profile of a BIMMF, relative to a pure fused quartz overclad (or substrate) tube 14 in a preform from which the fiber is drawn. A trench region 12 in FIG. 1 is typically obtained by depositing a depressed index glass on the inside diameter of the overclad tube 14, using either a modified chemical vapor deposition (MCVD) or a plasma chemical vapor deposition (PCVD) process. See, U.S. Pat. No. 7,903,918 (Mar. 8, 2011) which is incorporated by reference.

A glass core rod 16 is then inserted axially inside the overclad tube 14 to make the fiber preform, and the preform is heated vertically inside a furnace until the overclad tube 14 softens and collapses on the core rod 16 to form a drop at the bottom of the preform. The BIMMF is then drawn from the drop. It will be appreciated that among other drawbacks, the trench deposition process is very costly, ties up a lot of deposition capacity, and the resulting fiber is subject to yield loss related to axial trends in the deposited glass.

### SUMMARY OF THE INVENTION

According to the invention, a method of assembling a preform for a bend-insensitive multimode optical fiber (BIMMF), includes providing a multimode core rod, a glass over-cladding tube, and a trench tube of down-doped quartz glass with a depressed refractive index sufficient to obtain a desired trench depth in a refractive index (RI) profile of a drawn fiber. The core rod is placed coaxially inside the trench tube, and the trench tube and the core rod are placed coaxially inside the over-cladding tube to define the preform.

A top end of the trench tube is formed to contact an adjacent part of either the core rod or the over-cladding tube so that the trench tube is suspended to hang from the adjacent part when the preform is vertically oriented, and a bottom end of the trench tube is restrained from sinking into a lower portion of the preform when the preform is heated to collapse.

For a better understanding of the invention, reference is made to the following description taken in conjunction with the accompanying drawing and the appended claims.

### BRIEF DESCRIPTION OF THE DRAWING

In the drawing:

FIG. 1 is a refractive index difference profile of a bend insensitive multimode optical fiber (BIMMF) relative to a quartz overclad tube of a typical preform from which the fiber is drawn, according to the prior art;

FIG. 2 shows sectional views of a BIMMF preform in planes perpendicular and parallel to the axis of the preform, according to the invention;

FIG. 3 is a sectional view of an upper portion of a BIMMF preform in a plane parallel to the preform axis, according to a first embodiment of the invention;

FIG. 4 is a sectional view of a preform trench tube, an open end of which is heated by a torch to be reshaped;

FIG. 5 is a sectional view of an upper portion of a BIMMF preform in a plane parallel to the preform axis, according to a second embodiment of the invention;

FIG. 6 is a sectional view of a preform trench tube and an inserted core rod, wherein an open end of the tube is heated to be reshaped;

FIG. 7 is a sectional view similar to FIG. 6, including a pedestal for elevating the trench tube relative to the core rod prior to heating the open end of the tube;

FIG. 8 is a table showing average bend loss of a number of BIMMFs produced using a preform according to the invention; and

FIG. 9 is a refractive index difference profile of a bend insensitive multimode optical fiber (BIMMF) relative to an overclad tube in a preform from which the fiber was drawn, according to the invention.

### DETAILED DESCRIPTION OF THE INVENTION

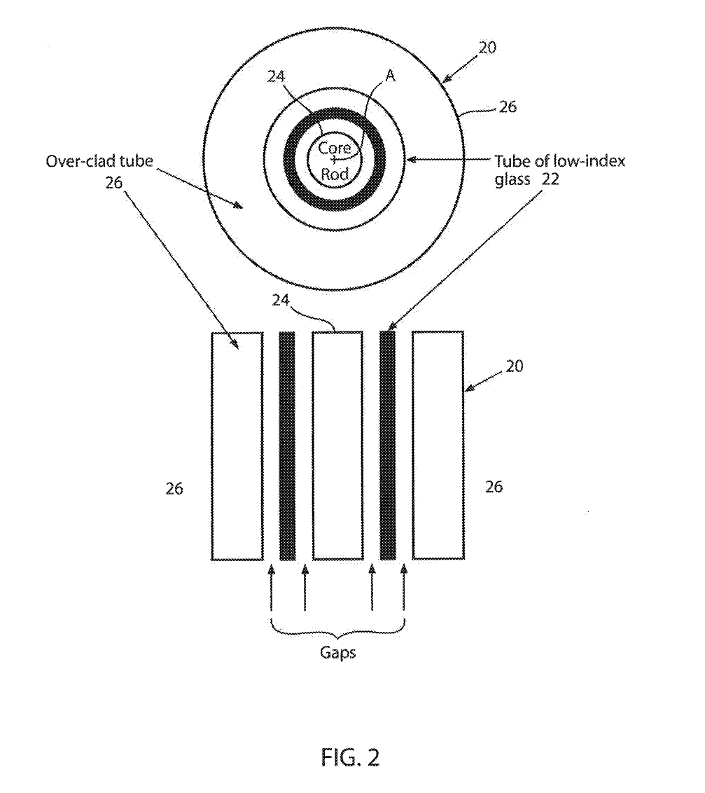

FIG. 2 shows sectional views of a cylindrical BIMMF preform 20 made according to the invention. The view at the top of FIG. 2 is taken in a plane transverse to the axis A of the preform 20, and the view at the bottom of FIG. 2 is shown parallel to the preform axis A. A tube 22 of down-doped or low-index glass (e.g., quartz) is supported inside the preform 20 so that the tube 22 is disposed coaxially with an inner core rod 24, and with a surrounding glass overclad tube 26 made of, e.g., pure fused quartz. The down-doped glass tube 22 is referred to herein as a “trench” tube.

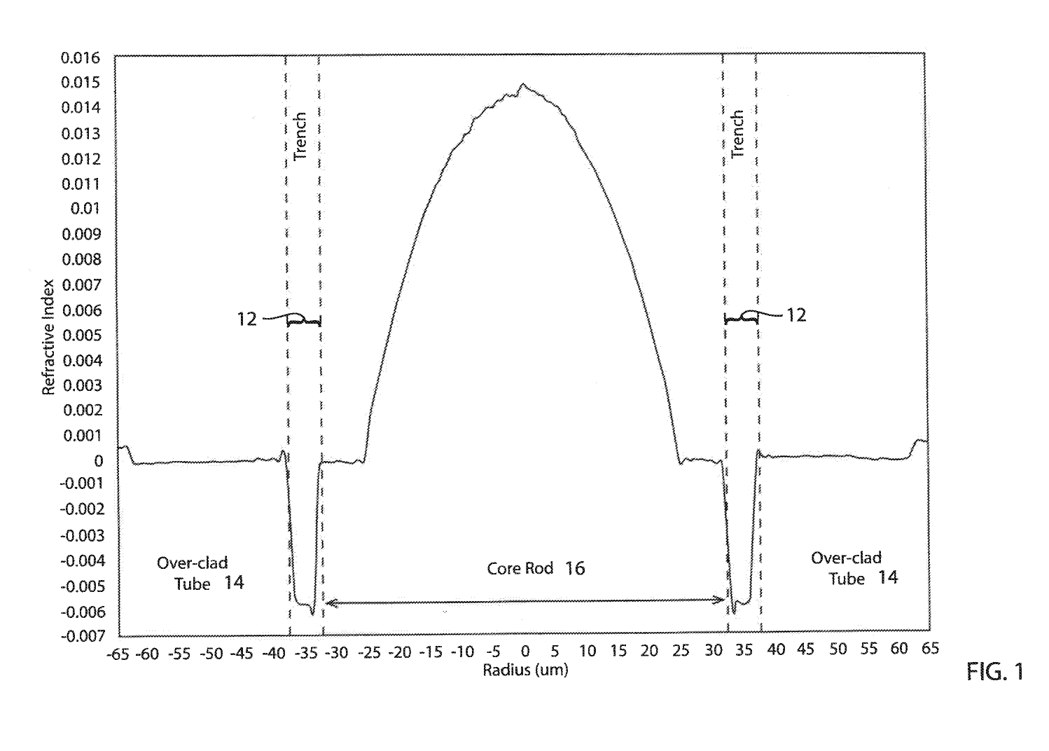

When the preform 20 is suspended vertically and lowered into a furnace or other heated region, the trench tube 22 and the surrounding overclad tube 26 collapses over the core rod 24, and a glass drop forms at the bottom of the collapsed preform 20. A BIMMF is then drawn from the bottom of the preform 20 in a known manner. The refractive index (RI) profile through the cladding of the drawn fiber has a trench region such as, e.g., the trench region 12 in FIG. 1, which region is formed by the collapsed trench tube 22 and enables the drawn fiber to be bend insensitive. Once the preform 20 has been collapsed, it can be withdrawn from the furnace in the collapsed state, allowed to cool, and heated again at a later time to draw more fiber.

Heating and collapsing the down-doped trench tube 22 and the surrounding overclad tube 26 simultaneously over the core rod 24 was found to be preferable to other possible solutions such as first collapsing the trench tube 22 horizontally on the core rod 24, and then collapsing the overclad tube 26 on the outer circumference of the trench tube 22 in a vertical furnace during the fiber draw process. The trench tube 22 will generally have a lower softening point than either of the core rod 24 or the overclad tube 26. If the trench tube 22 is simply dropped into the preform assembly to rest on its lower end, it was found to sink into the lower end of the preform during the fiber draw process, thus causing the trench region 12 in the fiber cladding to have an increased width and additional axial variability. To avoid this problem, it has been found that prior to heating, the trench tube 22 should be physically supported at its upper end so as to hang vertically inside the preform 20. In accordance with the invention, this is accomplished in either one of two ways:

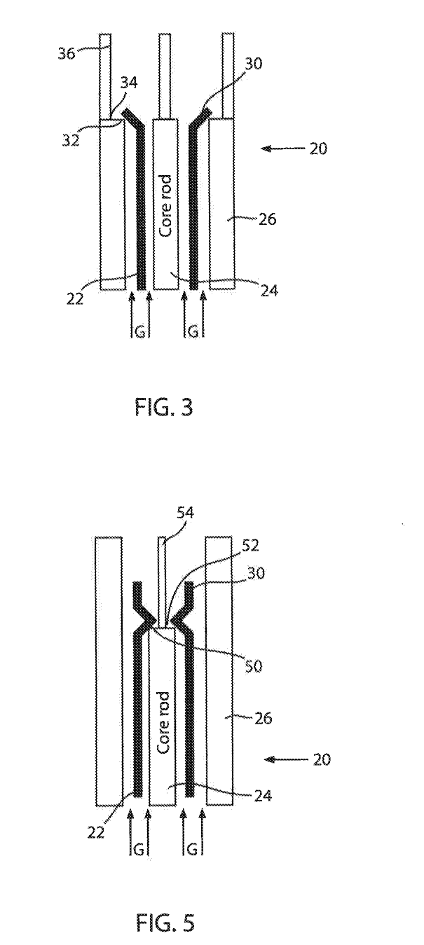

A. See FIG. 3. A top end 30 of the trench tube 22 is heated and flared radially outward or conically, so that the top end 30 of the tube abuts an inner circumferential edge 32 on the top end of the overclad tube 26 in the vicinity of a weld 34 between the overclad tube 26 and an associated tubular handle 36. Thus, the trench tube 22 is positively supported by the top end of the overclad tube 26 to hang vertically and coaxially inside the overclad tube to assemble the preform 20. Alternatively, a number of radially outward, circumferentially spaced protuberances can be formed at the top end of the trench tube 22 so that the protuberances abut the inner circumferential edge 32 of the overclad tube 26, allowing the trench tube 22 to be suspended and to hang vertically inside the overclad tube 26.

If a hydrogen-oxygen torch is used to heat the top end 30 of the trench tube 22 when flaring the top end outward, moisture and air particles may accumulate within the trench tube 22. This condensation can flow inside the trench tube 22 and contaminate the inside surface, causing, among other issues, prooftest breaks and voids in the drawn optical fiber if the trench tube 22 is not washed promptly after following the above steps. It was found that such contamination can be avoided by flowing a clean and filtered gas (e.g., Nitrogen) through the tube 22 during the heating process.

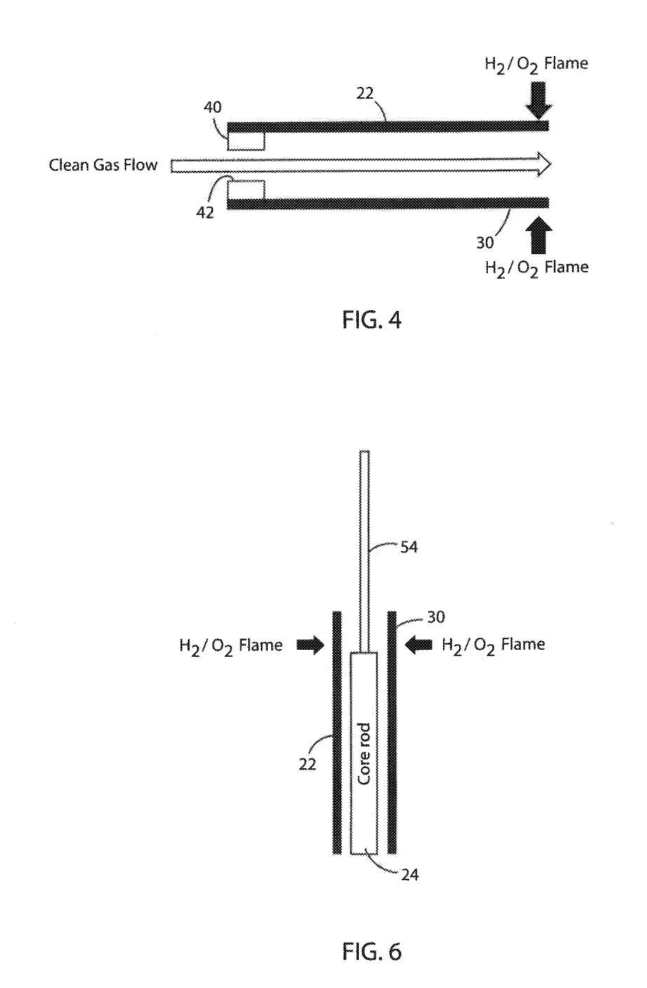

Specifically, as shown in FIG. 4, a stopper or seal such as a cork 40 is inserted in the open end of the trench tube 22 opposite to the end that is being heated to be flared, and clean gas is introduced through an axial passage 42 in the cork via a nozzle. As the gas flow exits the heated end of the trench tube 22, the flow prevents moisture and contamination from entering inside the tube.

B. See FIG. 5. Alternatively, the top end 30 of the trench tube 22 is formed to have an hourglass or necked-in shape, or with circumferentially spaced radially inward indentations or dimples, so that the top end of the tube abuts and is suspended to hang from a peripheral top edge 50 of the core rod 24, near a weld 52 between the core rod and a rod handle 54 after the tube passes over the handle 54. (The outside diameter of the handle 54 is typically less than that of the core rod 24). The trench tube 22 is thus firmly supported by the top edge 50 of the core rod 24 so as to hang vertically and coaxially inside the surrounding overclad tube 26. This process avoids a need to weld the trench tube 22 to any part of the core rod 24 or to the rod handle 54. And when the core rod 24 is raised by the handle 54, the trench tube 22 remains suspended from the top edge 50 of the rod.

If a hydrogen-oxygen torch is used to heat the top end 30 of the trench tube 22 prior to necking in the top end, or to forming the indentations in the top end, contamination of the inside surface of the tube can be avoided by making the trench tube at least 5 cm longer than the core rod 24. See FIG. 6. In this manner, the open top end of the trench tube 22 extends past the region of the tube to be heated, and the torch flame is not in the vicinity of the open top end 30. While there may be some local contamination on the outside surface of the tube 22 where the torch is applied, no condensation will accumulate on the inside surface of the tube. Method B is preferable to method A since it does not require gas flow apparatus or subsequent tube washing to eliminate concerns over contamination.

Further, in method B, it was found that if the necked-in or dimpled region of the trench tube 22 pinches directly against an area of the rod handle 54 that has residual stress, then the handle 54 may become weakened to crack either immediately or within hours after forming the dimpled region. If so, the core rod 24 could fall out of the open bottom end of the preform 20. Since there is typically a stress region in the rod handle 54 close to the weld 52 between the handle and the core rod 24, such stress can be relieved for example, by the use of a known slow annealing process prior to forming the necked in or dimpled region at the top end 30 of the trench tube. A faster solution that avoids such annealing was devised, wherein the trench tube 22 is temporarily raised relative to the core rod 24 while the necked in or dimpled region is formed in the top end of the tube.

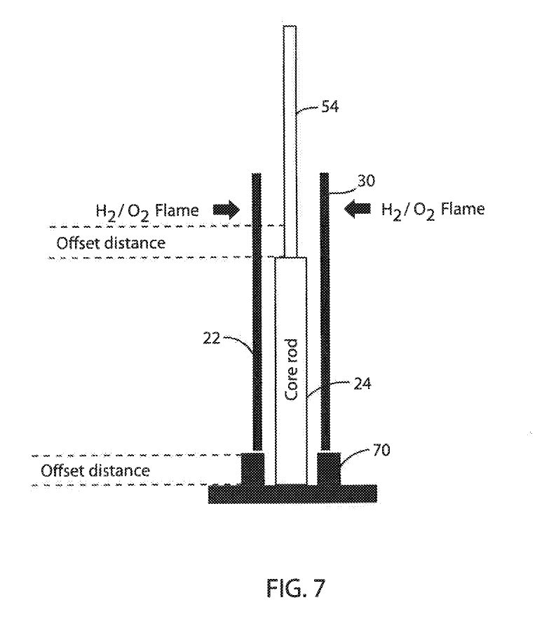

Specifically, as shown in FIG. 7, a pedestal 70 is used to elevate the trench tube 22 axially by a certain offset distance D relative to the core rod 24. When the tube is heated by a torch to be necked in or dimpled inwardly at its top end 30, the tube constricts or pinches against a region along the rod handle 54 that does not have stress regions. Thus, the strength of the handle 54 is not compromised. The pedestal 70 is removed and the trench tube 22 is lowered relative to the core rod 24 so that the tube then hangs from the top edge of the core rod 24 as described previously. While the necked in or inwardly dimpled region may be formed at the top end 30 of the tube before the core rod and rod handle are placed inside the tube, the pedestal technique in FIG. 7 overcomes situations where the rod handle 54 has a large diameter ball at its top end for supporting the handle and the rod 24 inside the overclad tube 26. In such cases, the ball could prevent the necked in region of the trench tube 22 from being moved downward along the handle to rest atop the core rod 24, thus requiring the trench tube to be moved upward from the bottom end of the core rod before the necked in region can be formed at the top end 30 of the trench tube.

Both of the methods A and B require that clearance gaps G shown in FIGS. 3 & 5 provided between the trench tube 22 and the inner core rod 24, and between the trench tube and the surrounding overclad tube 26, be kept as small as possible to minimize or avoid any radial asymmetry during a collapsing process. The gaps G are preferably as small as possible while allowing enough clearance for the core rod 24 to pass axially inside the trench tube 22. For example, the inside diameter of the trench tube 22 may be 1 mm to 2 mm larger than the outside diameter of the core rod.

It has also been discovered that both methods A and B work particularly well when the trench portion in the in the refractive index (RI) profile of the drawn fiber (e.g., portion 12 in FIG. 1) is situated relatively far from the RI profile of the fiber core.

### Example

Manufacturing a 50 μm bend insensitive multimode fiber

A preform 20 was assembled via the method of FIG. 5 (Method B) using the following components:
Core Rod 24 Diameter=24.5 mm
Core Rod 24 Length=1175 mm
Trench Tube 22 Inner Diameter=26.54 mm
Trench Tube 22 Outer Diameter=29.51 mm
Trench Tube 22 Length=1280 mm
Trench Tube 22 Delta Refractive Index (relative to pure quartz)=−0.0056
Overclad Tube 26 Inner Diameter=31.43 mm
Overclad Tube 26 Outer Diameter=47.77 mm
Overclad Tube 26 Length=1280 mm

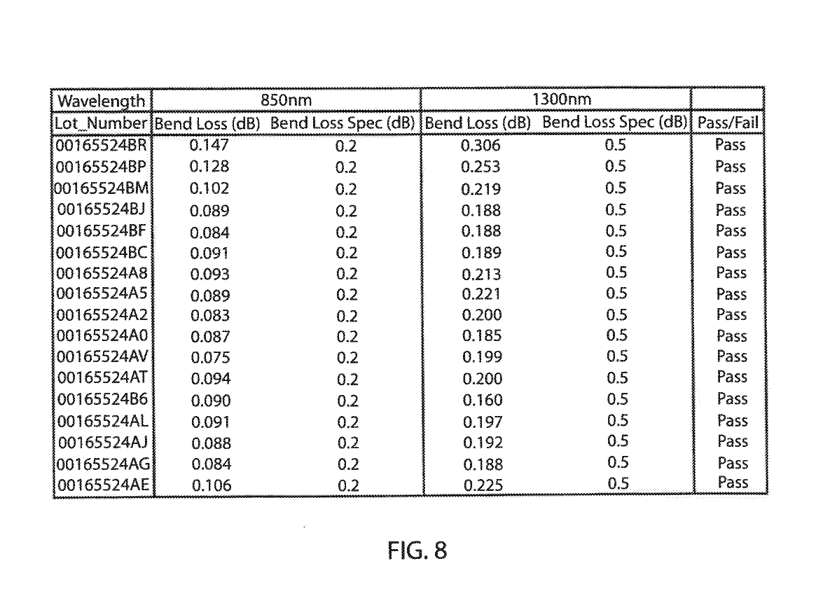

The assembled preform 20 was heated in a vertical furnace and a number of 50/125 μm bend insensitive multimode fibers were drawn, each having a length of approximately 8.8 km. Bend loss test results for the fibers are shown in FIG. 8. The data reflects additional loss induced by wrapping the fibers twice around a mandrel of radius 7.5 mm. Bend loss was measured at wavelengths of 850 nm and 1300 nm. Both ends of each fiber were tested and the average loss value is given for each test.

FIG. 8 shows that 100% of the fiber from the preform 20 passed currently specified bend loss test standards for BIMMFs. This is a significant improvement over prior BIMMF preform assembly and fiber drawing processes, wherein the trench in the RI profile of the drawn fiber tapers at one end, and many fibers fail to meet the specified standards. FIG. 8 also reflects an increased fiber yield with respect to the prior performs and processes, and increased uniformity that results from preventing the trench tube 22 from sinking during fiber draw.

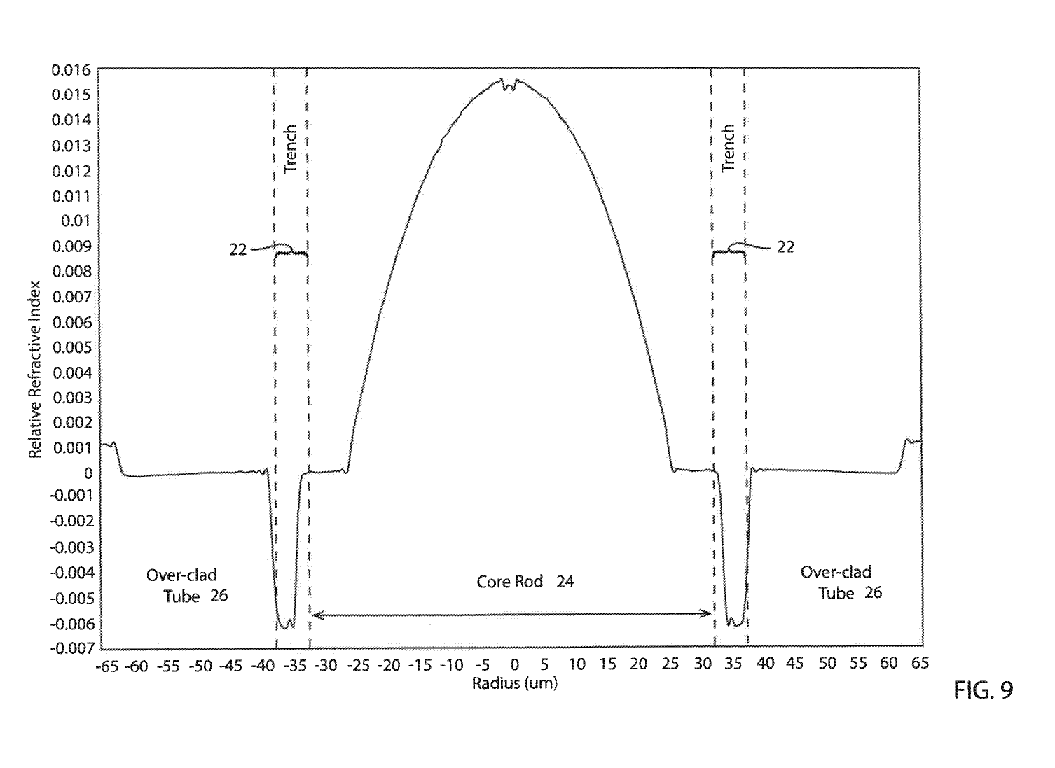

FIG. 9 is a typical RI difference profile of fibers that were drawn from the preform 20 of the present Example. Note that the profile in FIG. 9 is substantially identical to that in FIG. 1, thus confirming that the inventive preform and method produce a BIMMF having desired properties.

As disclosed herein, a bend insensitive multimode optical fiber is manufactured by placing a tube of down-doped quartz glass radially between an inner core rod and a surrounding overclad tube in a preform so that a trench region is formed in the index profile of the cladding of a drawn fiber. The preform is heated vertically in a furnace to collapse on the core rod, and the fiber is then drawn from the preform. Alternatively, once the preform collapses on the core rod, the preform can be withdrawn from the furnace and later re-heated for a fiber draw process. The inventive method provides higher productivity, lower cost, and higher fiber yield than the known prior methods.

While the foregoing represents preferred embodiments of the present invention, it will be understood by persons skilled in the art that various modifications, additions, and changes may be made without departing from the spirit and scope of the invention. For example, the dimensions and the RI of each component of the preform 20 may differ from the corresponding values given in the above Example, so that certain desired properties in the drawn BIMMF are obtained. Accordingly, the invention includes all such modifications, additions, and changes that are within the scope of the appended claims.

1. A method of assembling a preform for a bend-insensitive multimode optical fiber (BIMMF), comprising:
providing a multimode core rod;
providing a glass overclad tube;
providing a trench tube of down-doped quartz glass having a depressed refractive index sufficient to obtain a desired trench depth in a refractive index (RI) profile of the drawn fiber;
placing the core rod inside the trench tube, and placing the trench tube and the core rod inside the overclad tube to define a preform; and
forming a top end of the trench tube to contact an adjacent part of either the core rod or the over-cladding tube so that the trench tube is suspended to hang from the adjacent part when the preform is vertically oriented, and a bottom end of the trench tube is restrained from sinking into a lower portion of the preform when the preform is heated to collapse.

2. The method of claim 1, including flaring the top end of the trench tube for contacting an adjacent part of the over-cladding tube.

3. The method of claim 1, including welding a handle to a top end of the overclad tube, and flaring the top end of the trench tube for contacting the overclad tube in the vicinity of a weld between the overclad tube and the handle.

4. The method of claim 1, including flaring the top end of the trench tube radially outward.

5. The method of claim 1, including providing a number of radially outward projections at the top end of the trench tube.

6. The method of claim 1, including pinching the top end of the trench tube for contacting an adjacent part of the core rod.

7. The method of claim 1, including constricting or necking the top end of the trench tube inward.

8. The method of claim 1, including providing a number of radially inward projections at the top end of the trench tube.

9. The method of claim 1, including minimizing a gap between the trench tube and the core rod of the preform for avoiding asymmetry in the trench depth obtained in the RI profile of the drawn fiber.

10. The method of claim 1, including heating the assembled preform in a furnace, and collapsing the overclad tube and the trench tube onto the core rod.

11. The method of claim 10, including supporting the preform vertically inside the furnace, and drawing an optical fiber from a bottom end of the preform.

12. A preform for a bend-insensitive multimode optical fiber (BIMMF), comprising:
a multimode core rod;
a glass overclad tube;
a trench tube of down-doped quartz glass having a depressed refractive index sufficient to obtain a desired trench depth in a refractive index (RI) profile of a drawn fiber;
the core rod is disposed inside the trench tube, and the trench tube and the core rod are disposed inside the overclad tube to define a preform; and
a top end of the trench tube is formed to contact an adjacent part of either the core rod or the overclad tube so that the trench tube is suspended to hang from the adjacent part when the preform is vertically oriented, and a bottom end of the trench tube is restrained from sinking into a lower portion of the preform when the preform is heated to collapse.

13. A preform according to claim 12, wherein the top end of the trench tube is flared to contact an adjacent part of the over-cladding tube.

14. A preform according to claim 13, including a handle welded to a top end of the overclad tube, and the top end of the trench tube is flared to contact the overclad tube in the vicinity of a weld between the overclad tube and the handle.

15. A preform according to claim 12, wherein the top end of the trench tube is flared radially outward.

16. A preform according to claim 12, including a number of radially outward projections formed at the top end of the trench tube.

17. A preform according to claim 12, wherein the top end of the trench tube is pinched to contact an adjacent part of the core rod.

18. A preform according to claim 12, wherein the top end of the trench tube is radially constricted or necked inward.

19. A preform according to claim 12, including a number of radially inward projections formed at the top end of the trench tube.
